(19) United States
(12) Patent Application Publication
(10) Pub. No.: US 2017/0253749 A1
(43) Pub. Date: Sep. 7, 2017

(54) FLAME-RETARDANT COMPOSITION FOR TEXTILE SUBSTRATE

(71) Applicant: SAINT-GOBAIN ADFORS, Courbevoie (FR)

(72) Inventors: Samuel SOLARSKI, La Madeleine (FR); Clémence WABLE-KRAJCO, La Plaine Saint-Denis (FR)

(21) Appl. No.: 15/509,904

(22) PCT Filed: Sep. 9, 2015
(86) PCT No.: PCT/FR2015/052398

§ 371 Date: Mar. 9, 2017

(30) Foreign Application Priority Data
Sep. 9, 2014 (FR) 1458430

(51) Int. Cl. C09D 5/18; C09D 133/02; D03D 15/00; C08J 9/00; D06M 15/263; D03D 9/00; C03C 13/04; C08J 9/10

(52) U.S. Cl. CPC C09D 5/185; C03C 13/04; C09D 133/02; C08J 9/101; C08J 9/0066; C08J 9/0061; D06M 15/263; D03D 9/00; D03D 15/0011; C08J 2333/02; C08J 2400/102; C08J 2203/04; D06M 2200/30; D06M 2101/06

(57) ABSTRACT

A flame-retardant composition endowed with intumescent properties which consists of an acrylic resin, a dehydrating compound, a blowing agent and, optionally, a fluorocarbon-based polymer.

The present invention relates to a flame-retardant composition intended more particularly to be applied to a textile substrate comprising glass yarns and optionally synthetic yarns.

The flame-retardant composition makes it possible to form, on the textile substrate, a layer of transparent and flexible coating which becomes intumescent when it is exposed to heat or to fire. The textile substrate is thus made more fire resistant.

The fireproofing of textiles based on glass fibers is known and is obtained by applying a coating comprising an organic resin and intumescent compounds or fire-retardant additives, for example hydroxides or compounds based on phosphorus, on sulfur on on nitrogen.

The known intumescent flame-retardant coatings comprise mainly a melamine-formaldehyde resin which, admittedly, is transparent but which has the drawback of significantly reducing the flexibility of said coatings. In addition, these coatings are capable of giving off formaldehyde, which goes against the current regulations which prohibit formaldehyde because of harmful effects on living beings.

Flame-retardant coatings with fire-retardant additives make it possible to obtain the desired transparency and the desired flexibility, but their efficiency from the viewpoint of fire remains lower than that of intumescent flame-retardant coatings.

The technical problem addressed by the present invention is that of obtaining a formaldehyde-free, intumescent flame-retardant composition which is transparent and which makes it possible to preserve the flexible nature of the original textile substrate to which it is applied.

This problem is solved according to the invention by the flame-retardant composition which consists of an acrylic resin, a dehydrating compound, a blowing agent and, optionally, a fluorocarbon-based polymer.

In the present application, the following terms and expressions have the meanings hereinafter:

the term “dehydrating compound” is intended to mean a compound which releases a strong acid or a precursor of the latter which is capable of releasing a strong acid at a temperature above 100° C., preferably which ranges from 100 to 250° C.,

the term “blowing agent” is intended to mean a compound which releases non-inflammable gases such as carbon dioxide or ammonia when it thermally degrades. The blowing agent is a compound that is essential for obtaining the intumescence effect making it possible to form the expanded carbon-based structure which protects the textile substrate against fire. The blowing agent is different than the abovementioned dehydrating compound, and

the “transparent” or “transparency” nature is understood to mean relative to radiation in the visible range.

The function of the acrylic resin is to bind the fibers or the yarns to one another. The acrylic resin may consist of an acrylic or methacrylic acid homopolymer, or of a copolymer of acrylic and/or methacrylic acid and of an ethylenically unsaturated monomer such as styrene. Preferably, the resin consists of an acrylic acid homopolymer.

The function of the dehydrating compound is to dehydrate the acrylic resin and it must also make it possible to generate, under the effect of the increase in temperature, an acid which reacts with hydroxyl functions of said resin to give firstly a thermally stable ester. The ester will then be degraded, with production of carbon forming the fire-protecting layer, of water and of carbon dioxide.

The dehydrating compound is chosen from thermally degradable strong acids such as phosphoric acid, sulfuric acid and boric acid, and the salts of these acids having a volatile cation, and advantageously ammonium polyphosphates.

The blowing agent is preferably an amine or an amide, advantageously urea, melamine and guanidine. Urea is preferred.

As a general rule, the acrylic resin comprises a sufficient amount of carbon atoms and hydroxyl functions capable of reacting with the dehydrating agent to allow the formation of an intumescent layer of good quality. Thus, it not necessary to add, to the flame-retardant composition according to the invention, a polyhydric carbon-based compound different than the acrylic resin, in particular a polyol such as pentaerythritol, a sugar such as glucose, arabinose and maltose, a starch or a cellulose.

The flame-retardant composition in accordance with the present invention is in the form of an aqueous dispersion.

Preferably, the flame-retardant composition consists of (as % of solids):
10% to 60% of acrylic resin, advantageously 15% to 50%,
20% to 50% of dehydrating compound, advantageously 30% to 40%,
5% to 30% of blowing agent compound, advantageously 10% to 20%,
0% to 60% of fluorocarbon-based polymer, preferably at least 5%, and advantageously 10% to 30%.

The flame-retardant composition generally comprises 30% to 80% by weight of water, preferably 40% to 60%. The water content is adjusted according to the mode of application used to deposit the flame-retardant composition on the textile substrate, as is described later. By way of indication, the water content is, for example, equal to 40% when the flame-retardant composition is deposited by coating and equal to 60% for application by spraying.

In the flame-retardant composition, the fluorocarbon-based polymer contributes to improving the resistance to aging in a humid environment of the final textile substrate.

Another subject of the invention relates to a textile substrate coated with the abovementioned flame-retardant composition.

The textile substrate contains mineral fibers and/or yarns composed of a plurality of mineral filaments, and optionally organic fibers and/or yarns. The abovementioned mineral or organic fibers and yarns may be continuous or cut.

The mineral material which constitutes the abovementioned fibers and yarns may be glass or a rock, in particular a basalt.

The abovementioned organic fibers and yarns may be natural fibers and yarns, in particular based on cellulose, in particular on cotton, on flax and on hemp, or synthetic fibers and yarns, in particular based on a polymer, in particular a polyester, such as a poly(methyl methacrylate), or a polyolefin such as a polypropylene.

The textile substrate may be in the form of a nonwoven, for example a net or a mat of chemically or mechanically bound fibers, of a fabric, of a mesh, of a knit or of a braid.

Preferably, the textile substrate is a luminous fabric comprising optical fibers and binding yarns, in particular made of glass. Such fabrics are in particular described in patent applications WO 2005/026424, WO 2008/035010, WO 2008/062141 and WO 2008/087339.

Advantageously, the luminous fabric comprises optical fibers which may be made of glass but are preferentially organic fibers, and binding yarns made of glass.

The optical fibers advantageously consist of one or more polymeric materials.

The optical fibers and the binding yarns can be arranged in the warp or in the weft. The optical fibers are preferably placed in the weft and the glass yarns in the warp. Advantageously, the luminous fabric comprises glass yarns arranged in the warp and a combination of glass yarns and optical fibers arranged in the weft.

The luminous fabrics may comprise a plain, twill, satin or jacquard weave.

According to the type(s) of weaves chosen, it is possible to promote the presence of the optical fibers on one of the faces of the fabric while at the same time ensuring good strength of the fabric.

A first advantageous luminous fabric comprises at least one part which is woven according to a twill weave, advantageously a 4-, 6-, 8-, 10- or 12-harness satin weave. The choice of a satin weave enables the weft yarn or the warp yarn to be more visible on one of the faces of the luminous fabric. Advantageously, the luminous fabric comprises a weft-effect satin weave on the face used as lighting surface.

A second advantageous luminous fabric comprises at least one part that is woven according to a plain weave since this type of weave makes it possible to ensure good strength of the fabric.

As previously indicated, the optical fibers are preferentially organic, in particular consisting of one or more polymeric materials.

By way of example of such polymeric materials, mention may be made of poly(methyl methacrylate), polycarbonate, cycloolefins and fluoropolymers.

A sheath may cover the optical fibers (core) in order to protect them and to obtain two-component structures referred to as core-shell. The sheath may be of the same nature as that of the core or of a different nature than that of the core. Fibers comprising a poly(methyl methacrylate) core and a sheath based on a fluoropolymer such as a polytetrafluoroethylene are preferred.

The optical fibers generally have a diameter which ranges from 100 to 1000 μm, preferably from 200 to 550 μm and advantageously from 450 to 550 μm.

In the case of core-shell optical fibers, the thickness of the sheath is between 2 and 15 μm and preferably 5 and 10 μm.

The optical fibers have a density of at least 5 yarns/cm and preferably which ranges from 8 to 20.

The optical fibers can be treated so as to form invasive alterations which enable the extraction of light at the fibers and the diffuse illumination of the main surfaces of the luminous fabric. The invasive alterations are generally in the form of notches or small slits which can be obtained in particular by abrasive processes such as sandblasting, chemical attack or melting by means of a high-intensity light radiation such as a laser.

The invasive alterations can be made on the optical fiber before it is woven, or directly on the luminous fabric.

The glass yarns used as binding yarns consist of a plurality of glass filaments coated with a size, these filaments having a diameter which ranges from 5 to 24 μm, preferably 6 to 16 μm and advantageously 8 to 13 μm. The glass yarns also have a linear mass density which ranges from 2.8 to 4800 tex, preferably is greater than 34 tex, and advantageously which ranges from 50 to 800 tex.

The glass yarns arranged in the warp have a density at least equal to 5 yarns/cm, preferably at least equal to 7 and advantageously from 7 to 9. The glass yarns arranged in the weft have a density at least equal to 5 yarns/cm and preferably ranging from 8 to 20.

The glass yarns may be twisted yarns, the number of turns per meter being at least equal to 5 and preferably at least 20.

The glass yarns represent at least 20% of the weight of the luminous fabric and preferably at least 40%. The higher the proportion of glass yarns in the luminous fabric, the better the fire resistance.

The luminous fabric may comprise a structuring coating preferably applied to a face not used as lighting surface. This structuring coating is advantageously white in color and/or reflecting and/or predominantly based on a mineral material.

The structuring coating generally comprises a polymer organic binder and optionally filling materials consisting of mineral fillers and/or pigments. The polymer binder may be synthetic, for example a polyurethane, a poly(meth)acrylate, a styrene-butadiene or styrene-acrylic copolymer, or a natural polymer, for example a starch.

Although described more particularly in relation to luminous fabrics, the application of the flame-retardant composition to other textile substrates, in particular containing at least 20% by weight of an organic material, could not be excluded. For example, this textile substrate may be a complex comprising a structure made of glass and a nonwoven of polyester fibers, said nonwoven representing 50% to 85% by weight of polyester, or a fabric consisting of natural fibers, in particular a paintable cloth based on cellulose fibers, advantageously flax fibers.

The application of the flame-retardant composition to the textile substrate can be carried out by any means to known skilled in the art, for example by coating by means of a knife, optionally placed on a roll, by curtain coating, and by spraying.

The application of the flame-retardant composition is followed by a drying step which is generally carried out at ambient temperature (20-25° C.), but which can also be carried out at a higher temperature. The drying temperature should, however, be adjusted to the nature of the fibers and of the yarns of the textile substrate; in particular, it should not be too close to the temperature of degradation of the constituents of the flame-retardant composition and of the fibers and yarns.

By way of indication, the drying of luminous fabrics containing polymer fibers can be carried out at a temperature which ranges from 50 to 70° C., for a period which can range up to 60 minutes. Drying under these conditions improves the surface finish of the layer of flame-retardant composition.

The amount of flame-retardant composition applied to the textile substrate can vary to a large extent according to the desired level of fire resistance. Generally, the amount of flame-retardant composition (as % of solids) ranges from 50 to 400 g by square meter of textile substrate, preferably 100 to 300 g per square meter.

When the textile substrate is a luminous fabric, the flame-retardant composition is preferably applied to the face used as main lighting surface.

The examples given hereinafter make it possible to illustrate the invention without, however, limiting it.

In these examples, the properties of the textile substrate are evaluated under the following conditions:

The fire resistance is measured under the conditions of standard NF EN ISO 11925-2. The time for spread over a distance of 15 cm and the spread distance for a flame applied at the surface or to the edge of the sample are determined,

The luminance (in cd/m²) is measured under the conditions of standard ISO 23539:2005. The optical fibers of the sample to be tested are brought together in several groups and connected to a light source.

The flexural stiffness is measured on a rectangular sample (3.8 cm×8.0 cm) cut in the direction of the machine (relative to the direction of weaving) by means of a Lorentzen & Wettre apparatus, at 23° C. and 50% relative humidity.

The sample is held vertically at one end in the smallest dimension between two jaws and a horizontal force is applied to the free end. The force applied for a bend angle equal to 5° is measured and the stiffness S (in mN·m) is calculated according to the following formula:

S=60×F×L²/π×θ×b

in which:
F is the force measured to reach an angle of 5° (in mN)
L is the useful length of the sample (0.05 m)
θ the bend angle (5°)
b is the width of the sample (0.038 m).

### EXAMPLE 1

a) Textile Substrate

The textile substrate used is a fabric with an 8-harness satin weave consisting:

of E-glass binding yarns
in the warp: filament diameter 9 μm, linear mass density 68 tex, 20 turns/m Z direction (EC9 68 Z20), density 7.9 yarns/cm,
in the weft: filament diameter 11 μm, linear mass density 136 tex, 28 turns/m Z direction (EC11 136 Z28), density 12 yarns/cm, and

of optical fibers composed of a poly(methyl methacrylate) core coated with polytetrafluoroethylene: diameter 500 μm, linear mass density 240 tex, density 12 yarns/cm.

The fabric has a basis weight equal to 524 g/m² and contains 43% by weight of mineral materials.

A white structuring coating containing (as % by weight): 20% of a styrene-acrylic resin, 78% of calcium carbonate and 2% of titanium oxide is applied, by knife coating, to one of the faces of the luminous fabric (back face). The amount of structuring coating is equal to 181 g/m² of luminous fabric.

b) Flame-retardant Composition

A flame-retardant composition is prepared by adding the following constituents (as % of solids) to a container containing water:

| | |
|---|---|
| Acrylic resin (Aquaset ® TF 150; Dow Chemicals) | 49.0 |
| Ammonium polyphosphate (FR Cros ®484; Buddenheim) | 36.0 |
| Urea | 15.0 |

The solids content in the flame-retardant composition is equal to 60%.

A white-colored viscous solution is obtained.

c) Fireproofed Textile Substrate

La composition is applied to the front face of the luminous fabric described in a) by coating with a knife mounted on a roll, and then dried for 24 hours at ambient temperature (20-25° C.), in variable amounts.

The fabric of example 1e underwent a sandblasting treatment prior to the application of the flame-retardant composition.

The fire-resistance measurements of examples 1 a to 1e according to the invention are carried out compared with a luminous fabric which does not contain any structuring coating and flame-retardant composition (comparative example 1), a luminous fabric which does not contain any flame-retardant composition (comparative example 2) and a luminous fabric without structuring coating, in which the flame-retardant composition contains a melamine-formaldehyde resin (FX100; Flameseal) (comparative example 3).

The results are given in table 1.

The spread distance with application of the flame at the surface and to the edge of the luminous fabric is shorter (and therefore the fire resistance is better) for example 1d according to the invention compared with comparative example 3.

The luminous fabrics of examples 1a to 1e can undergo a manual bend up to a bend angle of 30° without visible damage to the layer of flame-retardant composition. Conversely, the luminous fabric of comparative example 3 cracks and disaggregates while releasing a pulverulent residue.

The luminance is measured on the luminous fabric of example 1e (fireproofed fabric) and it is compared to the luminance of this same fabric after sandblasting and before the application of the flame-retardant composition (non-fireproofed fabric). The results are the following:

| | Luminance (cd/m²) |
|---|---|
| Fireproofed fabric | 97.5 |
| Non-fireproofed fabric | 90.0 |

The transmission of light through the layer of flame-retardant composition is is slightly increased, thereby demonstrating the transparent nature of said layer.

### EXAMPLES 2 AND 3

The process is carried out under the conditions of example 1 modified in that the flame-retardant composition contains (as % of solids):

| | Ex. 2 | Ex. 3 |
|---|---|---|
| Acrylic resin (Aquaset ® TF 150; Dow Chemicals) | 44.0 | 39.0 |
| Ammonium polyphosphate (FR Cros ®484; Buddenheim) | 36.0 | 36.0 |
| Urea | 15.0 | 15.0 |
| Fluorocarbon-based polymer (Kappahob NI6; | 5.0 | 10.0 |
| Kapp Chemie) | | |

The results are given in table 1.

The luminous fabric of example 3 undergoes an accelerated aging test in a climatic chamber (temperature: 50° C., relative humidity: 80%) for 5 days.

The appearance of the layer of flame-retardant composition is comparable to that of the luminous fabric before accelerated aging treatment. This appearance is slightly better than that of a luminous fabric coated with a flame-retardant composition according to examples 1a and 1b.

The presence of the fluorocarbon-based polymer in the luminous fabric of example 3 makes it possible to have a good compromise between fire resistance and resistance to aging in a humid environment.

### EXAMPLES 4 AND 5

These examples illustrate the application of the flame-retardant composition to textile substrates containing fibers or yarns of organic material. The flame-retardant composition of example 1 is used to coat the following textile substrate:

a complex comprising a net of glass fibers, reinforced in the warp direction with glass yarns and a net of polyester yarns (grammage of the complex: 235 g/m²) in a proportion of 150 g/m² (example 4),

a fabric of flax yarns (grammage 250 g/m²) in a proportion of 144 g/m² (example 5).

The fire resistance and the flexural stiffness are measured compared with the same textile substrate not coated with the flame-retardant composition (comparative examples 4 and 5).

The results are given in table 2.

The flame-retardant composition gives examples 4 and 5 an improved fire resistance compared with the respective comparative examples 4 and 5.

The flexural stiffness of examples 4 and 5 is comparable to that of the textile substrate without flame-retardant composition.

The flame-retardant composition coating the textile substrates is transparent to the naked eye.

TABLE 1

| | Flame-retardant | Spread time | | Spread distance | |
|---|---|---|---|---|---|
| | composition | at 15 cm (s) | | (mm) | |
| | (g solids/m²) | Surface | Edge | Surface | Edge |
| Ex. 1a | 112 | 48 | 40 | Total | Total |
| Ex. 1b | 155 | 71 | 49 | Total | Total |
| Ex. 1c | 160 | n.d. | 87 | 70 | Total |
| Ex. 1d | 274 | n.d. | n.d. | 70 | 60 |
| Ex. 1e | 285 | n.d. | n.d. | 57 | 80 |
| Comp. | 0 | 20 | 12 | Total | Total |
| ex. 1 | | | | | |
| Comp. | 0 | 29 | 22 | Total | Total |
| ex. 2 | | | | | |
| Comp. | 272 | n.d. | n.d. | 80 | 75 |
| ex. 3 | | | | | |
| Ex. 2 | 132 | n.d. | 126 | 65 | Total |
| Ex. 3 | 135 | n.d. | 160 | 65 | Total |

n.d.: not determined

TABLE 2

| | Flame- | | | | | |
|---|---|---|---|---|---|---|
| | retardant | Spread time | | Spread | | Flexural |
| | composition | at 15 cm (s) | | distance (mm) | | stiffness |
| | (g solids/m²) | Surface | Edge | Surface | Edge | (mN · m) |
| Ex. 4 | 144 | n.d. | n.d. | 30 | 33 | 9.1 |
| Comp. ex. 4 | 0 | 19 | 12 | Total | Total | 8.2 |
| Ex. 5 | 150 | n.d. | n.d. | 55 | 65 | 1.8 |
| Comp. ex. 5 | 0 | 19 | 10 | Total | Total | 2.0 |

1. A flame-retardant composition, the flame-retardant composition comprising:
an acrylic resin,
a dehydrating compound,
a blowing agent, and
optionally, a fluorocarbon-based polymer compound.

2. The composition as claimed in claim 1, wherein the acrylic resin consists of an acrylic or methacrylic acid homopolymer, or of a copolymer of acrylic and/or methacrylic acid and of an ethylenically unsaturated monomer.

3. The composition as claimed in claim 2, wherein the acrylic resin consists of an acrylic acid homopolymer.

4. The composition as claimed in claim 1, wherein the dehydrating compound is chosen from thermally degradable strong acids as selected from the group consisting of a phosphoric acid, sulfuric acid and boric acid, and the salts of these acids having a volatile cation.

5. The composition as claimed in claim 4, wherein the dehydrating compound is an ammonium polyphosphate.

6. The composition as claimed in claim 1, wherein the blowing agent is an amine or an amide.

7. The composition as claimed in claim 1, comprising (as % of solids):
10% to 60% of acrylic resin,
20% to 50% of dehydrating compound,
5% to 30% of blowing agent compound,
0% to 60% of fluorocarbon-based polymer.

8. A textile substrate containing mineral fibers and/or yarns composed of a plurality of mineral filaments, and optionally organic fibers and/or yarns, wherein the textile substrate is coated with the flame-retardant composition as claimed in claim 1.

9. The textile substrate as claimed in claim 8, wherein the mineral fibers and/or yarns consist of glass or of rock.

10. The textile substrate as claimed in claim 8, wherein the organic fibers and/or yarns are natural or synthetic.

11. The textile substrate as claimed in claim 8, wherein the mineral or organic fibers and/or yarns are continuous or cut,

12. The textile substrate as claimed in claim 8, wherein the textile substrate is in the form of a nonwoven, of a fabric, of a mesh, of a knit or of a braid.

13. The textile substrate as claimed in claim 8, wherein the textile substrate is a luminous fabric comprising optical fibers and binding yarns.

14. The textile substrate as claimed in claim 13, wherein the optical fibers are glass fibers or organic fibers.

15. The textile substrate as claimed in claim 13, comprising at least one part which is woven according to a twill weave or a plain weave,

16. The textile substrate as claimed in claim 13, wherein the glass yarns represent at least 20% of the weight of the luminous fabric.

17. The textile substrate as claimed in claim 13, further comprising a structuring coating applied to a face not used as lighting surface.

18. The composition as claimed in claim 6, wherein the blowing agent is urea, melamine or guanidine.

19. The composition as claimed in claim 7, comprising (as % of solids):
15% to 50% of acrylic resin,
30% to 40% of dehydrating compound,
10% to 20% of blowing agent compound,
10% to 30% of fluorocarbon-based polymer.

20. The textile substrate as claimed in claim 9, wherein the mineral fibers and/or yarns consist of basalt,

21. The textile substrate as claimed in claim 10, wherein the organic fibers and/or yarns are based on cellulose or based on a polymer.

22. The textile substrate as claimed in claim 13, wherein the textile substrate is a luminous fabric comprising optical fibers and binding yarns made of glass.

23. The textile substrate as claimed in claim 14, wherein the optical fibers are organic fibers.

24. The textile substrate as claimed in claim 15, wherein the at least one part is woven according to a 4-, 6-, 8-, 10- or 12-harness satin weave.

25. The textile substrate as claimed in claim 16, wherein the glass yarns represent at least 40% of the weight of the luminous fabric.
